(19) United States
(12) Patent Application Publication
(10) Pub. No.: US 2005/0074570 A1
(43) Pub. Date: Apr. 7, 2005

(54) Fluoropolymer laminates

(76) Inventor: Purushottam Das Agrawal, Akron, OH (US)

Correspondence Address: WALKER & JOCKE, L.P.A., 231 SOUTH BROADWAY STREET, MEDINA, OH, 44256, US

(21) Appl. No.: 10/696,061

(22) Filed: Oct. 28, 2003

Related U.S. Application Data
(63) Continuation-in-part of application No. 10/677,543, filed on Oct. 1, 2003.

(51) Int. Cl. B32B 1/08; B32B 27/08; B32B 27/34; B32B 27/30; B32B 27/32; B29C 47/06; B32B 31/30

(52) U.S. Cl. 428/36.91; 156/244.11; 428/422; 428/522; 428/523; 428/474.4; 428/500

(57) ABSTRACT

Polymeric articles comprising a layer of fluoropolymer such as polytetrafluoroethylene bonded e.g. extruded onto a polymeric substrate derived from a polymeric blend comprising polyolefins, maleic anhydride-olefin copolymers, polyamides, thermoplastic polyurethanes, isoprene-styrene copolymers, and phenolic resins. The articles include fuel lines, tubes, hoses, containers, and sheet material for various uses.

### PRIOR APPLICATIONS

This application is a continuation-in-part of co-pending application Ser. No. 10/677,543 filed Oct. 1, 2003.

### FIELD OF THE INVENTION

This invention relates to multi-layer fluoropolymer laminates, to the process of preparing same, and to the use of said laminates in the preparation of various articles including fuel lines, hoses, and protective covers or lining resistant to various chemicals including fuels, oils, hydrocarbons, solvents and the like.

### BACKGROUND OF THE INVENTION

Multi-layer constructions containing fluorinated polymers have wide industrial applications. The multi-layer fluoropolymer laminates particularly have utility as fuel line hoses, tubing, containers and as sheeting material for various applications. More specifically, increased concern with fuel standards give rise need for fuel system components that have increased barrier properties to minimize the permeation of fuel and its vapors through components including fuel lines, fuel supply hoses, fuel tanks, and other components of fuel systems. Various constructions have been proposed to address these concerns. In general, the most successful are co-extruded multi-layer laminates. Generally fuel hoses used in fuel systems have multi-ply structures consisting of various rubber and resin layers. The two-ply fuel hose consist of a tubular inner ply and a thermoplastic resin or rubber outer ply laminated on the peripheral surface of said tubular inner ply.

A further problem with the construction of multi-layer fluoropolymers is the bond strength between the fluorinated polymer layer and the substrate layer such as a polyolefin layer. A variety of methods have been used to increase the bond strength between the fluorinated polymer layer and the non-fluorinated polymeric layer. For example, an adhesive can be added between these two layers. The shortcoming of adding an adhesive between the layers is that the process increases the complication of the manufacturing process because of the added step of applying the adhesive. Alternatively, either the fluorinated or the non-fluorinated polymeric layers can be exposed to various surface treatments; i.e., flame or plasma discharge treatment. The problem with these surface treatments is that the treatment can be temporary and delamination may occur during use of the product.

The advantages of preparing the articles of this invention e.g. hose or tubing includes lower cost, resistance to various chemicals, dirt and grime. Moreover, the polymeric layer or compositions of this invention provide improved adhesion to fluoropolymers without the need of an intermediate layer or other treatment between the fluoropolymer layer and the polymeric layer. The fluoropolymer layer and the polymeric layer are simply bonded e.g. co-extruded as the two layers are compatible.

### SUMMARY OF THE INVENTION

This invention relates to polymeric articles such as tubing, hoses, and sheet materials which comprises a first layer of fluoropolymer and a second layer comprising a polymeric blend bonded to the first layer. The second layer comprises a polymeric substrate derived from polymeric blends comprising from about 70 to 90 parts by weight of polyolefins, 2.0 to 16 parts by weight of maleic anhydride-olefin copolymers, and 2.0 to 12 parts by weight of polyamides.

In the preparation of the polymeric articles other than tubing or hoses such as various types of sheet material, the articles of this invention comprise a layer of fluoropolymer bonded to a preferred polymeric substrate derived from polymeric blends comprising from about 5 to 15 parts by weight of thermoplastic polyurethanes (TPU), 40 to 60 parts by weight of isoprene-styrene copolymers, 0.0 to 2.0 parts by weight of phenolic resin, 20 to 40 parts by weight of polyolefins, 2.0 to 20 parts by weight of polyamides and 2.0 to 16 parts by weight of maleic anhydride-olefin copolymers. The polymers can be coextruded as layers directly in contact with one another, so that the resultant adhesion between layers occurs without a tie layer being present, i.e., the coextrusion is carried out in the absence of any tie layer. When the coextruded laminate is in the form of tubing, the thickness of the layer can be about 8 mils (0.2 mm).

Accordingly, it is an object of this invention to provide fluoropolymer laminates for use in the preparation of tubing or hoses for transport and storage of various fuels, hydrocarbons and organic materials.

It is another object of this invention to provide fluoropolymer laminates useful as sheeting resistant to fuels, chemicals, dirt or grime.

It is a further object of this invention to provide fluoropolymers bonded directly to non-fluoropolymer polymeric substrates, and to provide the method of preparing said substrates.

These and other objects of this invention will become apparent from a further and more detailed description of the invention.

### DETAILED DESCRIPTION OF THE INVENTION

This invention relates to polymeric articles including tubing, hoses and various kinds of sheet materials. The invention provides articles i.e. hoses or tubes comprising a fluoropolymer layer bonded to a non-fluorinated polymeric substrate derived from a polymeric blend of melt-processable polymers comprising from about 70 to 90 and preferably 80 to 90 parts by weight of at least one lower molecular weight polyolefin, 2 to 16 and preferably 4 to 10 parts by weight of maleic anhydride-olefin copolymers wherein the preferable olefin is ethylene or propylene, and 2 to 12 and preferably 2 to 10 parts by weight of least one polyamide such as Nylon. Fluoroplastics, particularly polychlorotrifluoroethylene, polytetrafluoroethylene, copolymers of tetrafluoroethylene and hexafluoropropylene, have numerous chemical applications. Fluoroplastics per se are known to be useful, for example, in solid and lined pipes; see, “Organic Fluorine Compounds,” Kirk-Othmer, Encyclopedia of Chemical Technology, Vol. II.

In preparing the fluoropolymer sheet materials of this invention, the non-fluoropolymer polymeric blend, from which the polymeric substrate is derived, comprises from about 5 to 15 and preferably 6 to 12 parts by weight of a thermoplastic polyurethane (TPU), 40 to 60 and preferably 45 to 55 parts by weight of an isoprene-styrene copolymer, 0.0 to 2.0 and preferably 0.5 to 1.5 parts by weight of phenolic resin, 20 to 40 and preferably 25 to 35 parts by weight of at least one lower molecular weight polyolefin such as polyethylene or polypropylene, 2 to 20 and preferably 8 to 16 parts by weight of at least one polyamide such as Nylon-12, and 2.0 to 16 and preferably 4 to 10 parts by weight of a maleic anhydride-olefin copolymer wherein the preferred olefin is polyethylene or polypropylene.

The preferred fluoropolymers of this invention comprise the fluoropolymers available as RP-4020, RP-4040 and RP-5000, from Daikin America, Inc. under the trademark NEOFLON (EFEP-RP Series). These fluoropolymers have excellent physical and chemical properties having, for example, very low melting temperature characteristics in comparison to conventional thermoplastic. Typical properties of these fluoropolymers are shown in Table I.

TABLE I

| | | | | |
|---|---|---|---|---|
| Specific Gravity | — | ASTM D792 | 1.74 | 1.74 |
| Melting Point | ° C. | DSC | 160 | 160 |
| MFR (265° C., 5 kg) | G/10 min | ASTM D1238 | 25˜50 | 3˜8 |
| Tensile Strength | Mpa | ASTM D638 | 45 | 55 |
| Elongation | % | ASTM D638 | 500 | 450 |
| Flexural Modulus | Mpa | ASTM D790 | 1300 | n/a |
| Light Transmission | % | 250 mm | 87 | n/a |
| (100 micron film) | | | | |

However, since fluoropolymers are expensive, these polymers can be used in the form of a composite or multi-layer structure which reduces the amount of fluoropolymer required to produce the structure. In the manufacture of these multi-layer structures, e.g. laminates, the fluoropolymer is bonded to a polymeric substrate. Thus, the fluoropolymer and the polymeric substrate are combined, taking advantage of the useful properties of each material; i.e., the fluoropolymer layer can be a thin, flexible layer which provides resistance to fuel attack and/or barrier properties, while the polymeric substrate provides the desired strength and flexibility, at a substantial cost reduction.

With regard to the fluoropolymer constituting a layer of the coextruded laminate, the selected fluoropolymers should be melt extrudable, as indicated by having a melt viscosity in the range of 0.5×10³ to 60×10³. The preferred fluoropolymers are copolymers of ethylene with perhalogenated monomers such as tetrafluoroethylene (TFE) and chlorotrifluoroethylene (CTFE), which are referred to as ETFE and ECTFE, respectively. In the example of ETFE, minor amounts of an additional monomer can be used to improve the properties such as reduced high-temperature brittleness. The perfluoro polymers such as perfluorobutyl ethylene (PFBE), and hexafluoroisobutylene (HFIB) are some of the preferred comonomers. Of all the fluoropolymers, the most preferred fluoropolymer is TEFLON, a fully fluorinated copolymer of hexafluoropropylene and tetrafluoroethylene, and polytetrafluoroethylene.

The fluoropolymers and the polymeric blends of this invention can be coextruded by conventional methods, provided the extrusion is carried out under conditions where there is no degradation of the lower melting substrate. The coextruded laminates consist of two layers, one is the fluoropolymer layer and the other is the polymeric blend layer of this invention bonded together without any tie layer. The polymeric substrate, derived from the polymeric blends, provides strength to the overall sheets of laminate. When the laminate is in the form of tubing or hoses, the interior layer or inner surface of the tubing is usually the fluoropolymer layer. For example, the tubing or hose can range from about 0.025 to 0.1 mm or from about 0.001 to 0.05 inch thick. Coextruded tubing may be about 0.270 inches (6.86 mm) in the outer diameter and have a wall thickness of about 0.055 inch (1.4 mm) while the fluoropolymer inner layer ranges from about 0.006 to 0.06 inch thick.

Generally, the fluoropolymer can be extruded using a 1.0-inch (2.54-cm) extruder equipped with an extrusion screw at a barrel pressure of 410 psig (2.93 MPa) and at melt temperatures of about 510° F. (366° C.) entering the coextrusion forming the coextruded laminate. The polymeric blend can be extruded by using a 1.5-in extruder equipped with a screw and operating at a barrel pressure of about 600 psig, and at a melt temperature of about 400° F. entering the crosshead to form the coextruded laminate.

In preparing tubes or hoses, the olefin polymers and copolymers are present in the polymeric blends of this invention in amounts ranging from about 70 to 90 parts and in a preferred amount ranging from about 80 to 90 parts by weight. The preferred olefin polymers are ethylene and propylene and the copolymers include the ethylene-octene copolymers obtained from Exxon Mobil Chemicals under the trademark EXXPOL (EXACT 0201). The other olefinic polymers used in preparing these polymeric blends include ethylene or propylene copolymerized with various monomers such as the C₂-C₈ alphaolefins including propylene, butene-1,1-pentene, 4-methyl pentene-1, hexene-1 and octene-1.

The maleic anhydride-olefin copolymers are present in the polymeric blend for hoses or tubes in amounts ranging from about 2 to 16 parts and in a preferred amount ranging from about 4 to 10 parts by weight. The most preferred maleic-anhydride-ethylene copolymers are available from Exxon-Mobil under the trademark EXXELOR. EXXELOR-VA 1840 are maleic anhydride functionalized elastomeric ethylene copolymers. Typical properties of VA 1840 copolymer are shown in Table II.

TABLE II

| | Exxon Mobile Test | | Exxelor VA |
|---|---|---|---|
| Property | Method (based on) | Unit | 1803 |
| Maleic anhydride | FTIR EPK-04 QT-02 | | Medium (*) |
| graft level | | | |
| Melt flow rate index | ASTM D 1238 | g/10 min | 8.0 |
| (5 kg/230° C.) | | | |
| Density | DIN 53479 | g/cm3 | 0.88 |
| Glass transition | DSC | ° C. | −47 |
| temperature (Tg) | | | |
| Volatiles | AM-S 350.03 | % | 0.15 max. |
| Color | ASTM E 313-96 | Yellowness | 25 max |
| | | Index | |
| | | Pellet | |

Other maleic anhydride-olefinic copolymers useful in these polymeric blends are available as EXXELOR-VA 1803 from the Exxon Mobile Co. Exxelor VA 1803 is a high flow, amorphous ethylene copolymer functionalized with maleic anhydride by reactive extrusion. Its fully saturated backbone results in outstanding thermal and oxidative stability leading to enhanced weatherability. Moreover, its amorphous nature exhibits impact resistance at very low temperatures in blends with other polymers.

The polyamides in the non-fluorinated polymeric blends used in the preparation of hoses or tubes are generally commercially available. For example, polyamides such as the well-known Nylons are available from a number of sources. Particularly preferred polyamides are Nylon 6, Nylon 6,6, Nylon 11, or Nylon 12. The selection of a particular polyamide is based upon the physical requirements of the particular application for the resulting article. For example, Nylon 6 and Nylon 6,6 offer higher heat resistant properties than Nylon 11 or Nylon 12; whereas Nylon 11 and Nylon 12 offer better chemical resistance. In addition to those polyamides, other Nylons such as Nylon 6,12, Nylon 6,9, Nylon 4, Nylon 4,2, Nylon 4,6, Nylon 7, and Nylon 8 may be used in the polymeric blends. These polyamides are used in amounts ranging from about 2 to 12 and preferably 2 to 10 parts by weight of the substrates derived from the polymeric blends. Suitable Nylons which can be included in the blends of the present invention include those available from E.I. du Pont de Nemours under the Trademark ELVAMIDE.

In preparing fluoropolymer laminates with substrates derived from the polymeric blends of this invention for use in preparing various other articles e.g. sheeting in addition to hoses and tubes, the blends comprise other polymers including thermoplastic polyurethanes (TPU's). In preparing sheet articles, the thermoplastic polyurethanes are present in the polymeric blend in amounts ranging from about 5 to 15 parts and in preferred amounts ranging from about 6.0 to 12 parts by weight. The preferred thermoplastic polyurethanes are thermoplastic polyurethanes obtained from Dow Chemical Co. under the trademark, PELLETHANE 2102-80A. Other polyurethanes (TPU) useful in the polymeric blend of this invention are the modified polycaprolactone-based, polyester-based, and polyether-based thermoplastic polyurethanes. The polyether-based thermoplastic polyurethanes can be obtained from the Noveon Chemical Co. under the trademark ESTANE. These polyurethanes have the properties shown in Table III.

TABLE III

| | | |
|---|---|---|
| PROCESSING | Extrusion | Temperature 185-195° C. |
| | Injection Molding | Temperature 175-185° C. |

| MECHANICAL | | | |
|---|---|---|---|
| PROPERTIES | TEST METHOD | UNIT | VALUE |
| Hardness | DIN 53505 | Shore A/D | 88/ |
| Density | DIN 53479 | G/cm³ | 1.24 |
| Tensile strength | DIN 53504 | MPa | 31 |
| Elongation | | % | 655 |
| Tensile Stress at | | | |
| 50% Elongation | | MPa | 4.9 |
| 100% Elongation | | MPa | 5.5 |
| 300% Elongation | | MPa | 7.2 |
| Tear Resistance | DIN 53515 | KN/m | 45 |
| Abrasion loss | DIN 53516 | mm3 | 150 |
| Rebound resilience | DIN 53512 | % | 35 |
| Brittle Point | DIN 53546 | ° C. | −70 |
| Oxygen Index | ASTM D26603 | % | 30 |
| Vertical burn test | UL 94 | | V0 |

Other thermoplastic polyurethanes (TPU) useful in the blends of the present invention are commercially available; see, Rubber Technology, 2^{nd} edition, Chapter 17, Urethane Elastomers. Thermoplastic polyurethanes (TPU) are derived from the reaction of polyester or polyether polyols with diisocyanates and also from the reaction of components with chain-extending agents such as low molecular weight polyols, preferably diols, or with diamines to form urea linkages. Thermoplastic polyurethanes are generally composed of soft segments, for example polyether or polyester polyols, and hard segments, usually derived from the reaction of the low molecular weight diols and diisocyanates. While a thermoplastic polyurethane with no hard segments can be used, those most useful will contain both soft and hard segments. The processes for making TPU are well known and include single or multiple step polymerizations. In a single step polymerization, the diisocyanate, polyol and chain extending agent are combined and reacted, whereas in a multiple step process the polyol is first reacted with the diisocyanate to produce a prepolymer which is subsequently reacted with the chain extender to build molecular weight.

The styrene-olefinic block copolymers in the polymeric blends used in the preparation of sheeting are available from The Dow Chemical Co. as VECTOR 4111. VECTOR 4111 is a linear, pure SIS triblock copolymer with narrow molecular weight distribution. The polymer is a low styrene, low modulus copolymer. It contained <1% diblock. It is the softest pure SIS triblock and has the highest elasticity. The polymer has outstanding melt processability and is designed for use in elastomeric films or sheets and is a highly elastomeric composition. Specifically, VECTOR 4114 (diblock isoprene-styrene-isoprene-styrene) is a highly elastomeric polymer that can be substituted for VECTOR 4111. Further, a blend of VECTOR 4111 and 4114 also provides an elastomeric composition. The properties of VECTOR 4111 are shown in Table IV.

TABLE IV

| Properties | Test Method | Unit | Typical Value |
|---|---|---|---|
| Resin Properties | | | |
| Styrene | Dexco Method | Wt. % | 18 |
| Diblock Content | Dexco Method | Wt. % | <1.0 |
| MFR⁽¹⁾ | ASTM D 1238 | G/10 min | 12 |
| Ash | ASTM D 1416 | Wt. % | 0.3 |
| Physical Properties | | | |
| Tensile Strength⁽²⁾ | ASTM D 412 | PSI | 4000 |
| 300% Modulus⁽²⁾ | ASTM D 412 | PSI | 275 |
| Elongation⁽²⁾ | ASTM D 412 | % | 1200 |
| Hardness⁽³⁾ | ASTM D 2250 | Shore A | 39 |
| Specific Gravity | ASTM D 792 | g/ee | 0.93 |
| Product Form | | | Dense Pellet |

⁽¹⁾Condition (200° C./5 kg).
⁽²⁾Typical values on compressions molded plaques, intended only as guides and should not be construed as specifications.
⁽³⁾1 sec. Dwell.

The phenolic resins are present in the polymeric blends for sheet materials in preferred amounts ranging from about 0.5 to 1.5 parts by weight. These phenolic resins are available from the Schenectady International as SP-1045. The properties of these resins are given in Table V. SP-1045 Resins are heat reactive octylphenol-formaldehyde resins which contain methylol groups. This resin was specifically designed to cure isobutylene-isoprene (Butyl) rubber by the resin cure system. The octyl group makes SP-1045 Resins compatible with various elastomers.

TABLE V
SPECIFICATIONS

| Property | Min. | Max. | Test Method |
|---|---|---|---|
| Melting Point, Capillary, (° F.) | 140 | 150 | T06M01.01 |
| Softening Point, B&R, (° C.) | 80 | 95 | T06M02.01 |
| Methylol Content (%) | 8 | 11 | T17M01.02 |
| Color, Gardner, 64% in Toluene | 1 | 6 | T04M01.03 |

Other phenolic resins useful in the polymeric blends include the Novalac resins. Novalac resins are described in the Encyclopedia of Polymer Science and Engineering, Volume 11, pages 45-95 (1985). Thermoplastic Novolac resins are produced when a less than stoichiometric amount of formaldehyde is reacted with phenol in an acidic solution. In general, Novolacs do not contain hydroxymethyl groups and will not crosslink simply by heating. Examples of the Novolac resins include, but are not limited to, phenol-formaldehyde, resorcinol-formaldehyde, butyl-phenol-formaldehyde, ethyl-phenol-formaldehyde, hexyl-phenol-formaldehyde, propyl-phenol-formaldehyde, pentyl phenol-formaldehyde, octyl-phenol-formaldehyde, heptyl-phenol-formaldehyde, nonlyl-phenol-formaldehyde, and bisphenol-A-formaldehyde. The various Novolacs resins differ in the substituted groups, melting points, viscosities and other physical properties.

The following are examples of the polymeric blends of this invention used as substrates in the preparation of fluoropolymer laminates.

### EXAMPLE 1

(Hose/Tubes)

| | Parts by Weight |
|---|---|
| Inner Layer | |
| Fluoropolymer (EFEP/RP5000) | 100.00 |
| Outer Layer | |
| High Density polyethylene (HDPE) | 88.00 |
| Maleic anhydride-elastomeric ethylene | 8.00 |
| copolymer (VA 1840) | |
| Polyamides (Nylon 12) | 4.00 |

### EXAMPLE 2

(Hose/Tubes)

| | Parts by Weight |
|---|---|
| Inner Layer | |
| Fluoropolymer (EFEP/RP5000) | 100.00 |
| Outer Layer | |
| Polypropylene (COPP) | 88.00 |
| Maleic anhydride-propylene copolymer | 8.00 |
| (EXXELOR PO 1020) | |
| Polyamide (Nylon 12) | 4.00 |

### EXAMPLE 3

(Sheet material)

| | Parts by Weight |
|---|---|
| Outer Layer | |
| Fluoropolymer (EFEP-RP4020) | 100.00 |
| Second Layer | |
| Polyolefin (EXACT/ENGAGE 8450) | 30.00 |
| Thermoplastic polyurethane (TPU) | 10.00 |
| Maleic anhydride-ethylene copolymer | 7.00 |
| (VA 1840/1803) | |
| Polyamide (Nylon 12) | 4.00 |
| Isoprene-styrene-isoprene copolymer | 48.00 |
| (VECTOR 4114/4111) | |
| Phenolic Resin (SP-1045) | 1.00 |

The polymeric blend can be tumble blended on a two (2) inch extruder into a sheet die at a melt temperature of about 360° F. The fluoropolymer is laminated onto the polymeric blend. The laminate has excellent adhesion, and a peel strength greater than 25 psi. The adhesion between the layer of the fluoropolymer and the polymeric blend of the invention can be measured according to ASTM D-1876, known as the “T-Peel” test, using an INSTRON™ tensile tester, available from Instron Corporation, Minneapolis, Minn. The techniques for coextrusion and bonding of multilayer constructions or laminates are well known in the art and the disclosure thereof is not essential to the practice of the invention.

Modification of this invention will occur to one skilled in the art, and such modifications or changes are deemed to be within the scope of the invention as set forth in the appended claims.

1. A polymeric article comprising a layer of fluoropolymer bonded to a polymeric substrate; said substrate derived from a polymeric blend comprising from about 70 to 90 parts by weight of a polyolefin, 2.0 to 16 parts by weight of a maleic anhydride-olefin copolymer and 2.0 to 12 parts by weight of a polyamide.

2. The article of claim 1 wherein the copolymer is a maleic anhydride-ethylene copolymer.

3. The article of claim 1 wherein the polyolefin is an ethylene polymer present in the polymeric blend in an amount ranging from about 80 to 90 parts by weight.

4. The article of claim 1 wherein the fluoropolymer is polytetrafluoroethylene.

5. The article of claim 1 wherein the polyolefin is a copolymer of polyethylene, and the maleic anhydride-olefin is a copolymer of maleic anhydride and polypropylene.

6. The article of claim 1 wherein the fluoropolymer layer is laminated to the polymeric substrate by coextrusion.

7. A polymeric article comprising a layer of fluoropolymer bonded to a polymeric substrate; said substrate derived from a polymeric blend comprising from about 5 to 15 parts by weight of thermoplastic polyurethanes, 40 to 60 parts by weight of isoprene-styrene copolymers, 0.0 to 2.0 parts by weight of phenolic resins, 20 to 40 parts by weight of polyolefins, 2 to 20 parts by weight of polyamides, and 2.0 to 16 parts by weight of maleic anhydride-olefin copolymers.

8. The article of claim 7 wherein the polyurethanes are present in the blend in an amount of 6 to 12 parts, the isoprene-styrene are present in an amount of 45 to 55 parts, the phenolic resins are present in an amount of 0.5 to 1.5 parts, the polyolefins are present in an amount of 25 to 35 parts, the polyamides are present in an amount of 8 to 16 parts and the maleic anhydride-olefin copolymers are present in an amount of 4 to 10 parts by weight.

9. The article of claim 6 wherein the article is a fuel hose or tubing having the fluoropolymer as the inside layer.

10. The article of claim 7 wherein the article is laminated sheet material.

11. The article of claim 7 wherein the maleic anhydride-olefin copolymer is a copolymer of maleic-anhydride and polyethylene.

12. A process of preparing polymeric articles comprising extruding a layer of fluoropolymer onto a polymeric substrate; said substrate derived from a polymeric blend comprising from about 70 to 90 parts by weight of a polyolefin, 2.0 to 16 parts by weight of a maleic anhydride-olefin copolymer and 2.0 to 12 parts by weight of a polyamide.

13. The process of claim 12 wherein the polyolefin is selected from the group consisting of polyethylene and polypropylene.

14. The process of claim 12 wherein the maleic anhydride-olefin copolymer is a maleic anhydride-ethylene copolymer.

15. The process of claim 12 wherein the fluoropolymer is polytetrafluoroethylene.

16. A process of preparing polymeric sheet material which comprises extruding a layer of fluoropolymer onto a polymeric substrate; said substrate derived from a polymeric blend comprising from about 5 to 15 parts by weight of thermoplastic polyurethanes, 40 to 60 parts by weight of isoprene-styrene copolymers, 0.0 to 2.0 parts by weight of phenolic resins, 20 to 40 parts by weight of polyolefins, 2 to 20 parts by weight of polyamides, and 2.0 to 16 parts by weight of maleic anhydride-olefin copolymer.

17. The process of claim 16 wherein the fluoropolymer is polytetrafluoroethylene.

18. The process of claim 16 wherein the polyolefin is polyethylene.

19. The polymeric articles obtained by the process of claim 12.

20. The sheet material obtained by the process of claim 16.
